(19) United States
(12) Patent Application Publication
(10) Pub. No.: US 2015/0209835 A1
(43) Pub. Date: Jul. 30, 2015

(54) Pressure washer with cool 100% bypass device and method

(71) Applicant: David Heuckeroth, Thomaston, CT (US)

(72) Inventor: David Heuckeroth, Thomaston, CT (US)

(21) Appl. No.: 14/165,580

(22) Filed: Jan. 28, 2014

(51) Int. Cl. B08B 3/02; B05B 15/00

(52) U.S. Cl. CPC B08B 3/026; B05B 15/00

(57) ABSTRACT

Embodiments of the present invention disclose apparatuses and methods for a pressure washer with 100% cool bypass without the need for a soap or detergent metering valve, high pressure detergent, a booster pump, or thermal relief valve. The pressure washer can operate for extended periods of time without overheating.

### BACKGROUND OF THE INVENTION

Pressure washers are typically used to clean surfaces by spraying the surfaces with a pressurized stream of fluid. The fluid is usually directed to a surface using a spray gun which is activated by a trigger. The fluid can include heated water or an aqueous mixture of chemicals, usually soap or detergent. Pressure washers generally employ either a continuously operated pump, typically driven by a gasoline motor or an electrically driven pump with a motor that can be turned on or off by a micro-switch or other electrical switch. When fluid is flowing through the spray gun, it acts to cool the pump. However, when the spray gun is not activated, fluid does not exit the spray gun even if the device is in operation. if the pump continuously operates under this condition it may result in overheating of the device. To prevent overheating prior art devices have employed either a bypass, for continuously operated internal combustion driven devices or a switch to cut off power to the device for electrically powered devices. Devices employing a bypass have been of three types. These devices utilize high pressure soap or detergent delivered upstream of the pump by a metering valve which is downstream of a cleaning solution container. Either fluid entry from the fluid source or reservoir is stopped while fluid is diverted by an unloader valve and recirculated through the system downstream of an inlet filter or the fluid is partially recirculated downstream of an inlet filter and a portion diverted to a reservoir. The former devices require a thermal relief valve, which wastes soap or detergent. The latter provide partial overheating protection but can operate in bypass mode for only a limited period of time. Alternatively some devices redirect fluid from the unloader back to the reservoir. These devices when in bypass mode continue to add soap or detergent resulting in waste of soap or detergent through a siphoning effect.

### FIELD OF THE INVENTION

The embodiments of the present invention are related to pressure washer devices which typically direct a flow of press d fluid through a spray gun to the surface of an object to be rinsed or cleaned and more particularly to pressure washers employing a 100% cool bypass line for directing fluid from an unloader valve to a reservoir tank, and a valve to control water influx into a water supply tank. The system can be utilized with electric or internal combustion motor and does not require a soap metering valve, a thermal relief valve, electrical cut-off switch, mixer valve or booster pump and prevents overheating of the device for extended periods of time while the spray gun is not activated.

### DESCRIPTION OF RELATED ART INCLUDING INFORMATION DISCLOSED UNDER 37 CFR 1.97 AND 1.98

Related art as discussed under the heading of “Background of the Invention” includes the partial cool bypass pressure washer disclosed in U.S. Pat. No. 8,496,188 B2 to Linton, and similar devices disclosed therein.

### BRIEF SUMMARY OF THE INVENTION

In accordance with one embodiment, the subject matter of this application includes apparatuses and methods for a pressure washer with 100% cool bypass without the need for a soap or detergent metering valve, high pressure soap, a booster pump, or thermal relief valve. A detailed description and accompanying drawing, which is incorporated and constitutes part of the specification, explain the principles of these inventions.

### BRIEF DESCRIPTION OF THE SEVERAL VIEWS OF THE DRAWING(S)

FIG. 1 is a schematic of the pressure washer device in one embodiment.

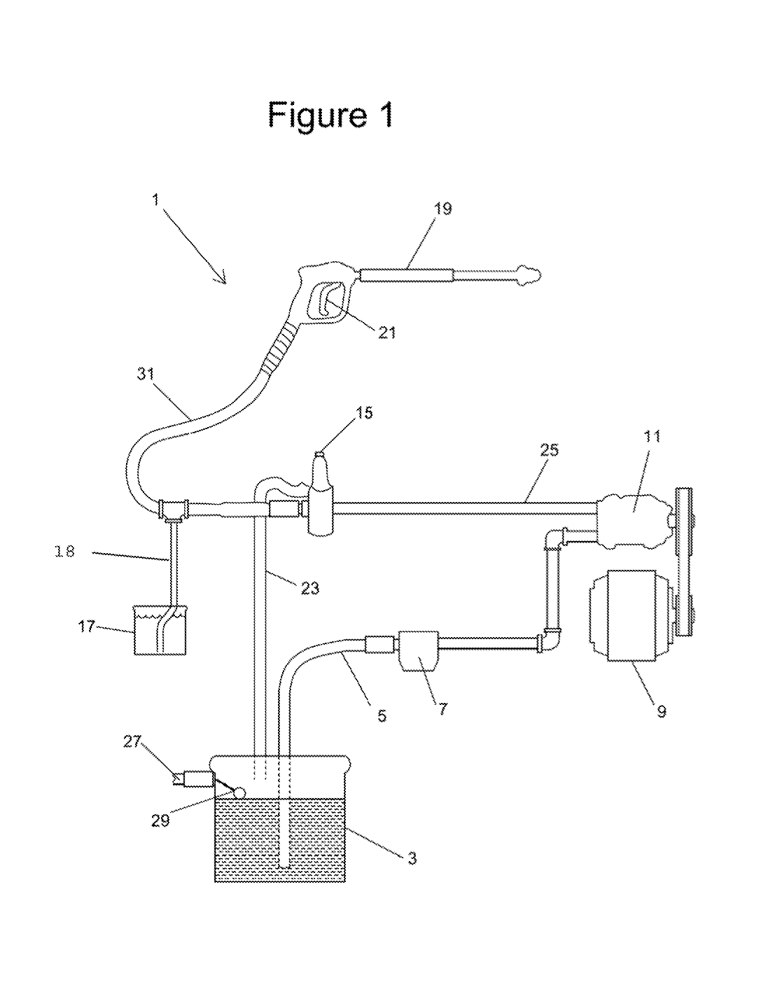

### DETAILED DESCRIPTION OF THE INVENTION

In an embodiment if the present invention water from a water source is directed to a fluid storage tank (3) through a supply hose (27). The flow of water entering the tank from the supply hose is regulated by a float valve assembly (29) to prevent overfilling the tank. Between the tank and pump (11) an in-line filter (7) is positioned to filter fluid directed toward the pump through the inlet conduit (5). The pump can be powered by a motor (9) which can be an internal combustion motor or an electric motor; the pump driven by a pulley drive system. Low pressure fluid originating from the tank is drawn by the pump and is directed through an outlet conduit (25) which extends from the pump to an unloader bypass valve (15). The outlet conduit and all other hoses and conduits can be constructed from any suitable materials. When the spray gun is activated by a user depressing the trigger, fluid is directed from the unloader valve through a high pressure hose (31) to the spray gun (19). Soap or detergent is suctioned from a detergent container (17). The detergent from the detergent container can enter the high pressure hose from a detergent line (12) positioned to insert into the high pressure hose between the unloader bypass valve and the spray gun. Detergent or soap from container (17) cannot be redirected to the pump because material in the high pressure hose is exclusively directed to the spray gun (19). When the trigger is not depressed, the spray gun is deactivated causing the pressure to increase within the outlet conduit thereby activating the unloader bypass valve to direct the entire fluid stream through a bypass hose (23) which returns the fluid to the tank. The warm fluid from the bypass hose mixes with the cool fluid in the tank. Cool fluid from the tank is thereby continuously fed to the pump. Because all of the heated water from the unloader bypass valve mixes with the cool tank water, the system can operate in bypass mode for extended periods of time without overheating. Furthermore, because soap or detergent is not redirected to the pump, high pressure soap or detergent is not required.

The foregoing merely illustrates the principles of the invention. For example, a twist nozzle could be substituted for the spray gun. it thus will be appreciated that those skilled in the art will be able to devise numerous alternative arrangements that, while not shown or described herein, embody the principles of the invention and thus are within its spirit and scope.

I claim:

1. A power washer system comprising:
a fluid storage tank,
a pump,
a bypass valve,
a pump inlet conduit having a first end in fluid communication with said fluid storage tank and a second end in fluid communication with the pump, said pump inlet conduit directing a detergent-free fluid to the pump,
a pump outlet conduit having a first end, wherein said first end is associated in fluid communication with the pump, and having a second end, said second end associated and in fluid communication with a bypass valve, thereby said outlet conduit being in fluidic communication with said bypass valve,
a high pressure hose having a first end associated in fluid communication with the outlet conduit and a second end which can be associated with and in fluid communication with a spray gun or in fluid communication with a nozzle,
a bypass hose connecting the bypass valve to said fluid storage tank,
a soap or detergent container and a soap or detergent line, said detergent line connecting the container to the high pressure hose at a point between the downstream from bypass valve, and, said spray gun or said nozzle,
wherein whenever fluid is not allowed to exit the system, up to 100 percent of the detergent-free fluid from the pump is directed by the bypass valve through the bypass hose to the fluid storage tank, and,
wherein when fluid is allowed to exit the system, fluid is not directed from the bypass valve to said fluid storage tank.

2. The power washer system of claim 1, further comprising,
a spray gun,
wherein said detergent line connecting said soap or detergent container to the high pressure hose at a point between said bypass valve and said spray gun or said nozzle.

3. The power washer system of claim 1, further comprising,
a nozzle,
wherein said detergent line connecting said soap or detergent container to the high pressure hose at a point between-said bypass valve and said nozzle.

4. The power washer system according to claim 2, further comprising,
a float valve assembly,
wherein said float valve assembly is positioned within said fluid storage tank and is configured to regulate the flow of fluid entering said fluid storage tank to prevent overfilling said fluid storage tank.

5. The power washer system according to claim 3, further comprising,
a float valve assembly,
wherein said float valve assembly is positioned within said fluid storage tank and is configured to regulate the flow of fluid entering said fluid storage tank to prevent overfilling said fluid storage tank.

6. A power washer system comprising:
a supply hose,
a fluid storage tank, said supply hose configured to deliver fluid to said fluid storage tank from an external source,
a bypass hose,
a bypass valve, said bypass valve configured to direct fluid to said bypass hose in response to pressure increases which occur when fluid cannot exit the system,
a pump inlet conduit, said pump inlet conduit positioned downstream relative to said fluid storage tank,
a pump outlet conduit, said pump outlet conduit positioned downstream relative to said pump inlet conduit, and further positioned to direct fluid from said pump to said bypass valve,
an in-line filter, said inline filter positioned to filter fluid flowing within said pump inlet conduit,
a pump, said pump positioned between said pump inlet conduit and said pump outlet conduit, said pump being in fluid communication with said pump inlet conduit and said pump outlet conduit,
a nozzle or a spray gun,
a high pressure hose, said high pressure hose positioned between said bypass valve and said nozzle or said spray gun, said high pressure hose receiving fluid from said bypass valve under fluid pressure conditions occurring when fluid exits the system through said nozzle or through said spray gun,
wherein said bypass hose connecting said bypass valve to said fluid storage tank and further configured to direct fluid from said bypass valve to said fluid storage tank when said bypass valve directs fluid to said bypass hose, and,
a soap or detergent container and a soap or detergent line, said soap or detergent line positioned to receive soap or detergent from said detergent container, and said soap or detergent line further positioned to deliver soap or detergent at a point downstream from said bypass valve.

7. The power washer system of claim 6, further comprising,
a float valve assembly,
wherein said float valve assembly is positioned within said fluid storage tank and is configured to regulate the flow of fluid entering said fluid storage tank from said supply hose to prevent overfilling said fluid storage tank.

8. A method for up to 100% cool bypass operation of a pressure washer comprising,
directing a detergent-free fluid from a source to a fluid storage tank,
directing a detergent-free fluid from said fluid storage tank to a pump inlet conduit,
directing a detergent-free fluid from said pump inlet conduit to a pump,
directing detergent-free fluid from said pump through a pump outlet conduit,
directing detergent-free fluid from said pump outlet conduit to a bypass valve,
directing detergent-free fluid from said bypass valve to a high pressure hose, wherein said high pressure hose is connected to and can deliver fluid to a spray gun or to a nozzle,
directing up to 100% of a detergent-free fluid from said bypass valve to a bypass hose when pressure increases while fluid cannot exit the system through said spray gun or through said nozzle,
delivering soap or detergent to the high pressure hose wherein soap or detergent enters the fluid flow downstream relative to said bypass valve.

9. The method according to claim 8 for up to 100% cool bypass operation of a pressure washer further comprising,
delivering soap or detergent to the high pressure hose from a soap or detergent container and a soap or detergent line, said soap or detergent line positioned to receive soap or detergent from said detergent container, and said soap or detergent line further positioned to deliver soap or detergent at a point downstream from said bypass valve.

10. The method according to claim 9 for up to 100% cool bypass operation of a pressure washer further comprising,
positioning a float valve assembly within said fluid storage tank,
wherein said float valve assembly is configured to regulate the flow of fluid entering said fluid storage tank from said supply hose to prevent overfilling said fluid storage tank.
